(19) United States
(12) Patent Application Publication
(10) Pub. No.: US 2026/0274130 A1
(43) Pub. Date: Sep. 17, 2026

(54) A SEAT SUSPENSION UNIT

(71) Applicant: UNO MINDA LIMITED, Gurgaon, Haryana (IN)

(72) Inventors: Rengasamy PACHAYAPPAN, Gurgaon, Haryana (IN); Saravanan D, Gurgaon, Haryana (IN); Siva Krishnan DURAISAMY, Gurgaon, Haryana (IN); Revanth CHILUKURY, Gurgaon, Haryana (IN); Aasetty Pandurenga MALLESWARA RAO, Gurgaon, Haryana (IN)

(21) Appl. No.: 19/167,252

(22) PCT Filed: Mar. 21, 2024
(86) PCT No.: PCT/IN2024/050289

§ 371 Date: Sep. 19, 2025

(30) Foreign Application Priority Data
Mar. 21, 2023 (IN) 202311018952

(51) Int. Cl. B60N 2/52; B60N 2/50

(52) U.S. Cl. CPC B60N 2/525; B60N 2/502

(57) ABSTRACT

The present disclosure relates to a seat suspension unit (20) of a vehicle. The seat suspension unit (20) comprises a seat support portion (22) connected to a seat (100), a base portion (24) connectable to a floor (102), and a compression assembly (26) positioned between and connected to the seat support portion (22) and the base portion (24). The seat suspension unit (20) further comprises a biasing arrangement (30), a fluid compressor (40), a fluid container (42), a plurality of fluid conduits (44, 46, 48), one or more adaptors (50), and at least one valve (56). The seat suspension unit (20) constructed in accordance with the present disclosure advantageously not only improves ease of adjustability, but also can provide greater comfort and safety to seat occupants by absorbing low frequency vibrations.

### TECHNICAL FIELD

Present disclosure generally relates to the field of automobile engineering. Particularly, but not exclusively, the present disclosure relates to a seat suspension unit. More particularly, the present disclosure relates to a low frequency seat suspension unit.

### BACKGROUND OF THE DISCLOSURE

The information in this section merely provides background information related to the present disclosure and may not constitute prior art(s) for the present disclosure.

A pneumatic suspension system generally uses compressed air to absorb shocks and vibrations received at body frame or at components connected to the body frame of a vehicle. In a vehicle seat, the pneumatic suspension system can provide a comfortable ride for the driver or passengers or a seated occupant by adjusting to different road conditions by absorbing bumps and vibrations. The pneumatic suspension systems are commonly used in a variety of vehicles, including commercial trucks and buses, off-road vehicles, and high-end luxury cars.

The pneumatic suspended seats are utilized to isolate the seated occupant from vibration during vehicle operation. Such cushioning usually utilizes the pneumatic suspension system for extension or compression which support the occupant's weight. However, because range of the seated occupant's weight is often more than 150 pounds and because of the relatively confined space in the commercial vehicles available for the seat, it is not only difficult to configure the pneumatic suspension system that fits in such a small space, but it is also a challenge to regulate the pneumatic suspension system supporting seat suspension to provide optimum comfort.

Referring to FIG. 1, illustrated a conventional seat suspension unit (10). The seat suspension unit (10) is disposed in between a seat (100) and a floor (102) of a vehicle (not shown). The seat suspension unit (10) comprises an air spring (2), an air compressor (4), and a pneumatic valve (6). A scissor linkage (8) is positioned between the seat (100) and the floor (102). However, the conventional configuration has space constraints, due to which the compressed air volume that can be stored in the air spring (2) is limited. Due to which a low frequency vibration cannot be absorbed by the conventional seat suspension unit (10). The low frequency vibrations in vehicles refer to a type of vibration that occurs at a relatively low frequency, typically between 2 and 20 Hz. This type of vibration is often felt as a deep rumble or shaking sensation and can be caused by various factors such as engine and transmission imbalance, suspension issues, and drivetrain problems.

The present disclosure is directed to overcome one or more limitations stated above or any other limitations associated with the seat suspension unit.

The drawbacks/difficulties/disadvantages/limitations of the conventional techniques explained in the background section are just for exemplary purposes and the disclosure would never limit its scope only such limitations. A person skilled in the art would understand that this disclosure and below mentioned description may also solve other problems or overcome the other drawbacks/disadvantages of the conventional arts which are not explicitly captured above.

### SUMMARY OF THE DISCLOSURE

One or more shortcomings of the prior art are overcome by the system/assembly as claimed, and additional advantages are provided through the provision of the system/assembly/method as claimed in the present disclosure. Additional features and advantages are realized through the techniques of the present disclosure. Other embodiments and aspects of the disclosure are described in detail herein and are considered a part of the claimed disclosure.

In one non-limiting embodiment, a seat suspension unit is disclosed. The seat suspension unit comprises a seat support portion connectable to a seat and a base portion connectable to a vehicle floor. A linkage assembly is interposed between the seat support portion and the base portion. A biasing arrangement is configured to engage the seat support portion to resist collapse of the linkage assembly. Additionally, a fluid container is disposed below the seat and configured to store compressed fluid. The fluid container is connected to the biasing arrangement in order to provide low frequency suspension based on fluid pressure within the biasing arrangement.

In an embodiment of the present disclosure, the linkage assembly includes a scissor linkage assembly having at least a pair of first scissor link and a second scissor link to facilitate relative movements between the seat support portion and the base portion.

In an embodiment of the present disclosure, the biasing arrangement is a pneumatic spring.

In an embodiment of the present disclosure, the seat suspension unit comprises a fluid compressor adapted to supply compressed fluid to the fluid container.

In an embodiment of the present disclosure, the seat suspension unit comprises at least one valve connected to the fluid container. The at least one valve is configured to selectively release fluid from the fluid container to regulate the pressure of the fluid container.

In an embodiment of the present disclosure, the seat suspension unit includes a plurality of fluid conduits. The plurality of fluid conduits comprises a first fluid conduit configured to connect the fluid container with the at least one valve, a second fluid conduit configured to connect the fluid compressor to the fluid container, and a third fluid conduit configured to connect the fluid container to the biasing arrangement.

In an embodiment of the present disclosure, the first fluid conduit is a 4 mm hose, the second fluid conduit is a 6 mm hose, and the third fluid conduit is a 10 mm hose.

In an embodiment of the present disclosure, the seat suspension unit comprises one or more adaptors facilitating fluid connections between the fluid compressor, the fluid container, and the biasing arrangement.

In an embodiment of the present disclosure, the one or more adaptors include a plurality of orifices connectable to the plurality of fluid conduits respectively.

In one non-limiting embodiment, a method of operating a seat suspension unit in a seat is disclosed. The method comprises the step of supplying compressed fluid from a fluid compressor to a fluid container via a second fluid conduit, regulating the desired fluid pressure within the fluid container. After that, transferring compressed fluid from the fluid container to a biasing arrangement via a third fluid conduit, facilitating the engagement of a seat support portion to the biasing arrangement through a linkage assembly. Maintaining fluidic communication between the fluid container and at least one valve via a first fluid conduit. The biasing arrangement is configured to oppose collapsing of the linkage assembly and support a seat occupant sitting in the seat.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF FIGURES

The novel features and characteristics of the disclosure are set forth in the description. The disclosure itself, however, as well as a preferred mode of use, further objectives, and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 illustrates the schematic view of the seat suspension unit mounted under a seat in accordance with a prior art.

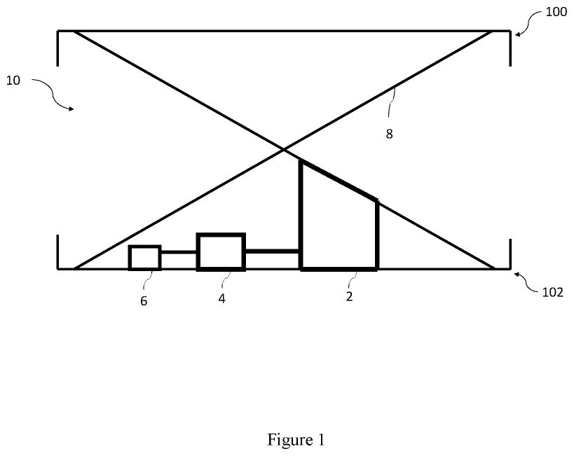

FIG. 2 illustrates the schematic view of the seat suspension unit mounted under the seat in accordance with an embodiment of the present disclosure.

FIG. 3 illustrates the schematic view of the seat suspension unit in accordance with an embodiment of the present disclosure.

FIG. 4 illustrates the schematic view of an air accumulator connected to an adaptor in accordance with an embodiment of the present disclosure.

Skilled artisans will appreciate that elements in the drawings are illustrated for simplicity and have not necessarily been drawn to scale. For example, the dimensions of some of the elements in the drawings may be exaggerated relative to other elements to help to improve understanding of embodiments of the present disclosure.

### DETAILED DESCRIPTION

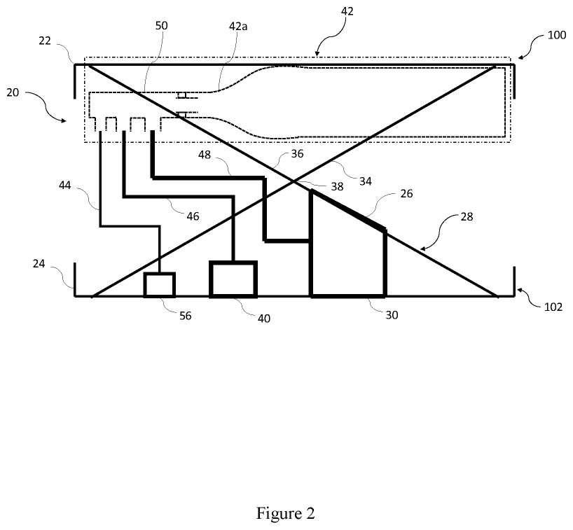

While the disclosure is susceptible to various modifications and alternative forms, specific embodiment thereof has been shown by way of example in the FIGS. 2 to 4 and will be described in detail below. It should be understood, however that it is not intended to limit the disclosure to the particular forms disclosed, but on the contrary, the disclosure is to cover all modifications, equivalents, and alternative falling within the spirit and the scope of the disclosure as defined by the appended claims.

Before describing in detail embodiments, it may be observed that the novelty and inventive step that are in accordance with the present disclosure resides in a seat suspension unit. It is to be noted that a person skilled in the art can be motivated from the present disclosure and modify the various constructions of the seat suspension unit. However, such modification should be construed within the scope of the disclosure. Accordingly, the drawings are showing only those specific details that are pertinent to understanding the embodiments of the present disclosure so as not to obscure the disclosure with details that will be readily apparent to those of ordinary skill in the art having benefit of the description herein.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprises”, “comprising”, or any other variations thereof, are intended to cover a non-exclusive inclusions, such that a device that comprises a list of components does not include only those components but may include other components not expressly listed or inherent to such setup or device. In other words, one or more elements in a system or apparatus proceeded by “comprises . . . a” does not, without more constraints, preclude the existence of other elements or additional elements in the system or apparatus.

Reference will now be made to the exemplary embodiments of the disclosure, as illustrated in the accompanying drawings. Wherever possible, same numerals will be used to refer to the same or like parts. Embodiments of the disclosure are described in the following paragraphs with reference to FIGS. 2 to 4. In FIGS. 2 to 4, the same element or elements which have same functions are indicated by the same reference signs.

The present disclosure relates to a seat suspension unit (20) that can have many applications including use with seats on off-road vehicles such as lift trucks, trackers, skid steer loaders, compact excavators, and the like. FIG. 2 illustrates a schematic view of the seat suspension unit (20) positioned between and connected to a seat (100) and a floor (102) of a vehicle (not shown), in accordance with an embodiment of the present disclosure. The seat suspension unit (20) includes a seat support portion (22) connected to the seat (100), a base portion (24) connectable to the floor (102), and a compression assembly (26) positioned between and connected to the seat support portion (22) and the base portion (24). In an embodiment, the compression assembly (26) is disposed below the seat (100). The compression assembly (26) enables relative movements between the seat support portion (22) and the base portion (24) when, for example, a person sits down on the seat (100).

The seat suspension unit (20) includes a linkage assembly (28). In an embodiment, the linkage assembly (28) is a scissor linkage assembly (28) as shown in FIG. 2. The scissor linkage assembly (28) is interposed between the seat support portion (22) and the base portion (24). The seat suspension unit (20) further comprises a biasing arrangement (30) which is carried by the base portion (24). The biasing arrangement (30) engages the seat support portion (22) in a manner that opposes the scissor linkage assembly (28) collapse and that supports a seat occupant (not shown) sitting on the seat (100). In an embodiment, the scissor linkage assembly (28) includes at least a pair of first scissor link (34) and a second scissor link (36) connected by a pivot (38) that allows relative rotation thereabout. In an embodiment, the base portion (24) is grounded to a body frame of the vehicle (not shown) in which the seat (100) is mounted.

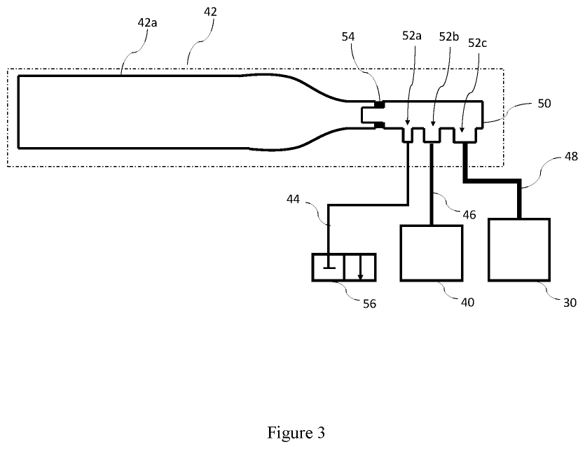

Referring to FIG. 3, the seat suspension unit (20) further comprises a fluid compressor (40), a fluid container (42) also known as an air accumulator, a plurality of fluid conduits (44, 46, 48), one or more adaptors (50), and at least one valve (56). In an embodiment, the biasing arrangement (30) is a pneumatic spring. In an embodiment, the biasing arrangement (30) is made of a flexible, compressible material such as a bellow, a bladder, and the like. However, other types of materials can be selected without limiting the scope of the present disclosure. In an embodiment, the fluid compressor (40) is electrically powered, such as by being connected to an electrical system of the vehicle. In an embodiment, a variety of fluids can be compressed by the fluid compressor (40), including air, nitrogen, carbon dioxide, other gases, and gas mixtures. In an embodiment, the fluid container (42) is made of aluminium and/or plastic. In an exemplarily embodiment, the fluid container (42) may withstand the pressure requirement till 20 bar.

Referring to FIG. 3 again, the plurality of fluid conduits (44, 46, 48) comprises a first fluid conduit (44), a second fluid conduit (46), and a third fluid conduit (48). The first fluid conduit (44) connects the fluid container (42) with the at least one valve (56). The second fluid conduit (46) is configured to connect the fluid compressor (40) to the fluid container (42). In an embodiment, the fluid compressor (40) can include a pressure gauge (not shown) to indicate the pressure in the second fluid conduit (46). The third fluid conduit (48) is configured to connect the fluid container (42) to the biasing arrangement (30). In an embodiment, the first fluid conduit (44) is a 4 mm hose, the second fluid conduit (46) is a 6 mm hose, and the third fluid conduit (48) is a 10 mm hose, without limiting the scope of the present disclosure. In an embodiment, the plurality of fluid conduits (44, 46, 48) can be made from a variety of materials, including but not limited to, rubber, PVC, nylon, and polyurethane.

In an embodiment, the at least one valve (56) is configured to release fluid from the fluid container (42). The at least one valve (56) is connected to the fluid container (42) by the first fluid conduit (44). In an embodiment, the at least one valve (56) is configured to release fluid from at least one of the fluid container (42) and the biasing arrangement (30) without limiting the scope of the present disclosure. In an embodiment, the at least one valve (56) is a pneumatic relief valve. In an embodiment, the seat suspension unit (20) comprises an adjustment arm (not shown in Figures) which configures the at least one valve (56) in a manner that selectively regulates the pressure of the fluid container (42). Accordingly, by adjusting the adjustment arm, the at least one valve (56) releases fluid from the fluid container (42). The release of fluid from the fluid container (42) regulates the amount of resistance the biasing arrangement (30) provides in resisting the collapse of the scissor linkage assembly (28).

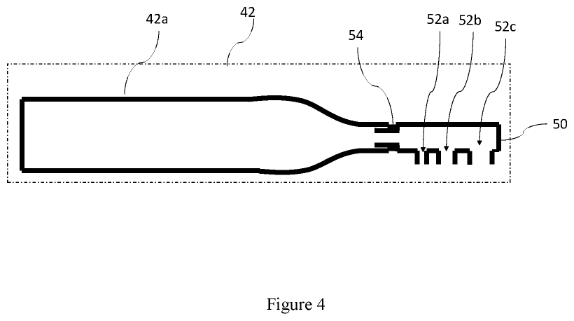

Referring to FIG. 4, the fluid container (42) is illustrated. The fluid container (42) includes a cylindrical chamber (42a) configured to store compressed fluid, under required pressure. In an embodiment, the fluid container (42) is made of Aluminium material. However, other types of materials can be selected without limiting the scope of the present disclosure. One or more adaptors (50) are connected to one end of the fluid container (42). In an embodiment, one or more adaptors (50) include external grooves to mate with the internal grooves of the fluid container (42). In an embodiment, the one or more adaptors (50) include three orifices (52a, 52b, 52c) of different sizes. The three orifices (52a, 52b, 52c) are connectable to the plurality of fluid conduits (44, 46, 48) respectively. The positions of the three orifices over the adaptor (50) are provided as per alignment with the plurality of fluid conduits (44, 46, 48). The connections of the plurality of fluid conduits (44, 46, 48) with the three orifices (52a, 52b, 52c) of the adaptor (50) are advantageous in quick response against small vibrations. A sealing member (54) is used in order to fluidly seal one or more adaptors (50) with the fluid container (42). In an embodiment, the one or more adaptors (50) are made of elastomeric material. However, other types of materials can be selected without limiting the scope of the present disclosure.

A method of operation of the seat suspension unit (20) is now disclosed in accordance with the present disclosure. When the fluid compressor (40) is electrically powered, the second fluid conduit (46) supplies the compressed fluid from the fluid compressor (40) to the fluid container (42) with the desired fluid pressure. Once the compressed fluid is filled in the fluid container (42), the third fluid conduit (48) supplies the compressed fluid from the fluid container (42) to the biasing arrangement (30). Furthermore, the first fluid conduit (44) maintains a fluidic communication between the fluid container (42) and the at least one valve (56). When the fluid container (42) and the biasing arrangement (30) are charged as described above, the higher pressure of the biasing arrangement (30) engages the seat support portion (22) in a manner that opposes collapsing of the scissor linkage assembly (28) and that supports the seat occupant sitting in the seat (100). During operation, the vehicle equipped with the seat (100) constructed in accordance with the present disclosure encounters jolts, bumps and the like is better dampened and isolated by the seat suspension unit (20).

The seat suspension unit (20) constructed in accordance with the present disclosure advantageously not only improves ease of adjustability, but it also is capable of supporting seat occupants, e.g., vehicle operators, having a greater range of weights. Such a seat suspension unit (20) is advantageously well-suited for use in a wide variety of vehicles, including off-road vehicles, watercraft, and the like. Further, routing of the plurality of the fluid conduits (44, 46, 48) ensures a quick response against small vibrations. Furthermore, the inclusion of the fluid container (42) in the disclosed seat suspension unit (20) lowers the natural frequency of the seat (100) by increasing the fluid volume in a series of biasing arrangement (30). Accordingly, the seat suspension unit (20) provides greater comfort and safety by absorbing small vibrations.

The main objective of a seat suspension unit as disclosed in the present disclosure is to increase air volume in a pneumatic suspension system.

Another objective of the present disclosure is to provide an additional air accumulator configured to provide low frequency suspension.

One more objective of the present disclosure is to provide hose routing configured to act in response against small vibration.

One more objective of the present disclosure is to provide greater comfort to occupant of a vehicle seat by lowering the natural frequency of the seat by increasing the air volume.

Yet another objective of the present disclosure is to provide the seat suspension unit that can be fitted under the seat.

The various embodiments of the present disclosure have been described above with reference to the accompanying drawings. The present disclosure is not limited to the illustrated embodiments, rather, these embodiments are intended to fully and completely disclose the subject matter of the disclosure to those skilled in this art. In the drawings, like numbers refer to like elements throughout. Thicknesses and dimensions of some components may be exaggerated for clarity.

Herein, the terms “attached”, “connected”, “interconnected”, “contacting”, “mounted”, “coupled” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

While considerable emphasis has been placed herein on the particular features of this disclosure, it will be appreciated that various modifications can be made and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

### EQUIVALENTS

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

LIST OF REFERENCE NUMERALS

| Reference Number | Description |
|---|---|
| 20 | Seat suspension unit |
| 22 | Seat support portion |
| 24 | Base portion |
| 26 | Compression assembly |
| 28 | Scissor linkage assembly |
| 30 | Biasing arrangement |
| 34 | First scissor link |
| 36 | Second scissor link |
| 38 | Pivot |
| 40 | Fluid compressor |
| 42 | Fluid container or Air accumulator |
| 42a | Cylindrical chamber |
| 44 | First fluid conduit |
| 46 | Second fluid conduit |
| 48 | Third fluid conduit |
| 50 | Adaptor |
| 52a, 52b, 52c | Orifice |
| 54 | Sealing member |
| 56 | Valve |
| 100 | Seat |
| 102 | Floor |

We claim:

1. A seat suspension unit (20) comprising:
a seat support portion (22) connectable to a seat (100) and a base portion (24) connectable to a floor (102);
a linkage assembly (28) interposed between the seat support portion (22) and the base portion (24);
a biasing arrangement (30) configured to engage the seat support portion (22) to resist collapse of the linkage assembly (28); and
a fluid container (42) disposed below the seat (100) and configured to store compressed fluid;
wherein the fluid container (42) is connected to the biasing arrangement (30) in order to provide low frequency suspension based on fluid pressure within the biasing arrangement (30).

2. The seat suspension unit (20) as claimed in claim 1, wherein the linkage assembly (28) includes a scissor linkage assembly (28) having at least a pair of first scissor link (34) and a second scissor link (36) to facilitate relative movements between the seat support portion (22) and the base portion (24).

3. The seat suspension unit (20) as claimed in claim 1, wherein the biasing arrangement (30) is a pneumatic spring.

4. The seat suspension unit (20) as claimed in claim 1, wherein the seat suspension unit (20) comprises a fluid compressor (40) adapted to supply compressed fluid to the fluid container (42).

5. The seat suspension unit (20) as claimed in claim 1, wherein the seat suspension unit (20) comprises at least one valve (56) connected to the fluid container (42), the at least one valve (56) is configured to selectively release fluid from the fluid container (42) to regulate the pressure of the fluid container (42).

6. The seat suspension unit (20) as claimed in claim 5, wherein the seat suspension unit (20) includes a plurality of fluid conduits (44, 46, 48), the plurality of fluid conduits (44, 46, 48) comprising:
a first fluid conduit (44) configured to connect the fluid container (42) with the at least one valve (56);
a second fluid conduit (46) configured to connect the fluid compressor (40) to the fluid container (42); and
a third fluid conduit (48) configured to connect the fluid container (42) to the biasing arrangement (30).

7. The seat suspension unit (20) as claimed in claim 6, w % herein the first fluid conduit (44) is a 4 mm hose, the second fluid conduit (46) is a 6 mm hose, and the third fluid conduit (48) is a 10 mm hose.

8. The seat suspension unit (20) as claimed in claim 6, wherein the seat suspension unit (20) comprises one or more adaptors (50) facilitating fluid connections between the fluid compressor (40), the fluid container (42), and the biasing arrangement (30).

9. The seat suspension unit (20) as claimed in claim 8, wherein the one or more adaptors (50) include a plurality of orifices (52a, 52b, 52c) connectable to the plurality of fluid conduits (44, 46, 48) respectively.

10. A method of operating a seat suspension unit (20) in a seat (100), comprising:
supplying compressed fluid from a fluid compressor (40) to a fluid container (42) via a second fluid conduit (46), regulating desired fluid pressure within the fluid container (42);
transferring compressed fluid from the fluid container (42) to a biasing arrangement (30) via a third fluid conduit (48), facilitating engagement of a seat support portion (22) to the biasing arrangement (30) through a linkage assembly (28);
maintaining fluidic communication between the fluid container (42) and at least one valve (56) via a first fluid conduit (44);
wherein the biasing arrangement (30) is configured to oppose collapsing of the linkage assembly (28) and support a seat occupant sitting in the seat (100).
